(19) United States
(12) Patent Application Publication
(10) Pub. No.: US 2012/0118496 A1
(43) Pub. Date: May 17, 2012

(54) Method of making bamboo-surfaced layered Venetian blind slats

(76) Inventor: Zeyun CHEN, ZHEJIANG PROVINCE (CN)

(21) Appl. No.: 13/175,951

(22) Filed: Jul. 5, 2011

(30) Foreign Application Priority Data
Nov. 17, 2010 (CN) 201010555035.3

(51) Int. Cl. B32B 38/04

(52) U.S. Cl. 156/250

(57) ABSTRACT

The present invention relates to a method of making bamboo-surfaced layered Venetian blind slats comprising the steps of (1) selecting bamboo slices, the length of each is slightly longer than that of the slats to be made, the width of each is the total width of a plurality of the slats to be made; (2) selecting filling slices, the length and width of each are identical to those of the bamboo slices; (3) selecting adhesives and using the adhesives to adhere a bamboo slice, a filling slice, a bamboo slice in turn to form a layered slat piece and all adjacent slices are adhered to one another along their fibers with their tight and loose surfaces arranged symmetrically; (4) placing the layered blind slat piece into a flat plate mold with a large surface area, and a flat plate with a large surface area is thus formed from compression; (5) cutting along the longitude of the flat plate with a large surface area to obtain bamboo-surfaced layered Venetian blind blank slats; (6) trimming the remains of the cutting surfaces and the two end surfaces of the bamboo-surfaced layered Venetian blind blank slats, and bamboo-surfaced layered Venetian blind slats are obtained. The beneficial effects are reduction of wood consumption, high production efficiency, low production cost, and small deformation of products such as bending, twisting and warping and thus prolonging the usable period of the products.

### BACKGROUND OF THE INVENTION

The present invention relates to a method of making bamboo-surfaced Venetian blind slats and more particularly pertains to a method of making bamboo-surfaced layered Venetian blind slats.

Owing to the shading, dimmable and well-ventilated effects of Venetian blinds, Venetian blinds are extensively used in offices, hotels, conference rooms and homes.

In the prior art, the method of making Venetian blind slats by processing plants is to chop a round wood log to obtain cut-logs of lengths required to make the blind slats first and then cut along the longitude of wood fibers to obtain wood plates of thickness required to make the blind slats. After that cut along the longitude of wood fibers again to obtain blank slats of the blind slats. Polish the plain, side and end surfaces of the blank slats to finish making the Venetian blind slats. The disadvantages of the method are that consumption of raw wood materials is high causing substantial damages to primeval forests, production efficiency is low, production cost is high, and deformation of products such as bending, twisting and warping is serious.

### BRIEF SUMMARY OF THE INVENTION

In view of the aforesaid disadvantages now present in the prior art, the present invention provides a method of making bamboo-surfaced layered Venetian blind slats, which can reduce the consumption of wood, reduce the damages to primeval forests, achieve high production efficiency, low production cost, and small deformation of products such as bending, twisting and warping and thus prolong the usable period of the products.

To attain this, the method of making bamboo-surfaced layered Venetian blind slats of the present invention comprises the steps of: (1) selecting bamboo slices, the length of each is slightly longer than that of the slats to be made, the width of each is the total width of a plurality of the slats to be made, the thickness of each is 0.18 mm to 0.42 mm, the longitude of the bamboo slices follows that of the bamboo fibers; (2) selecting filling slices, the length and width of each are identical to those of the bamboo slices, the thickness of each is 0.6 mm to 2.0 mm, the longitude of the filling slices follows that of their fibers; (3) selecting adhesives and using the adhesives to adhere a bamboo slice, a filling slice, a bamboo slice in turn to form a layered slat piece and all adjacent slices are adhered to one another along their fibers with their tight and loose surfaces arranged symmetrically; (4) placing the layered slat piece into a flat plate mold with a large surface area to form a flat plate with a large surface area from compression; (5) cutting along the longitude of the flat plate with a large surface area to obtain bamboo-surfaced layered Venetian blind blank slats; (6) trimming the remains of the cutting surfaces and the two end surfaces of the bamboo-surfaced layered Venetian blind blank slats, and bamboo-surfaced layered Venetian blind slats can be obtained.

The bamboo slices can be done by rotary slicing of the raw bamboo or the assembled laminated bamboo material or by plain slicing the assembled laminated bamboo material.

The filling slices are fast growing wood slices or bamboo slices.

The adhesives are wood glue.

There can be one filling slice or two filling slices or multiple filling slices.

The beneficial effects of the method of making bamboo-surfaced layered Venetian blind slats according to the present invention are that it is able to reduce wood consumption, reduce damages to primeval forests, achieve high production efficiency, low production cost, and small deformation of products such as bending, twisting and warping and thus prolong the usable period of the products.

Tight surfaces and loose surfaces are formed on bamboo and wood materials when they undergo rotary slicing and plain slicing. In order to reduce deformation after they are adhered and restructured, all adjacent slices are adhered to one another along their fibers with their tight and loose surfaces arranged symmetrically so that internal stress between two symmetrical planes could counteract with each other. Accordingly, dimensions of the blind slats could be significantly enhanced with respect to their stability, and deformation such as bending, twisting and warping could be reduced during the process of use.

### BRIEF DESCRIPTION OF THE DRAWINGS

FIG. 1 is a schematic illustration of the first embodiment of the method of making bamboo-surfaced layered Venetian blind slats according to the present invention.

FIG. 2 is the enlarged view of the part marked I in FIG. 1.

FIG. 3 is a schematic illustration of the second embodiment of the method of making bamboo-surfaced layered Venetian blind slats according to the present invention.

FIG. 4 is the enlarged view of the part marked II in FIG. 3.

FIG. 5 is a schematic illustration of one of the blind slats in FIG. 1 obtained after cutting and trimming.

FIG. 6 is a schematic illustration of one of the blind slats in FIG. 3 obtained after cutting and trimming.

### DETAILED DESCRIPTION OF THE INVENTION

The present invention is further described in detail with reference to the accompanying drawings and the following embodiments.

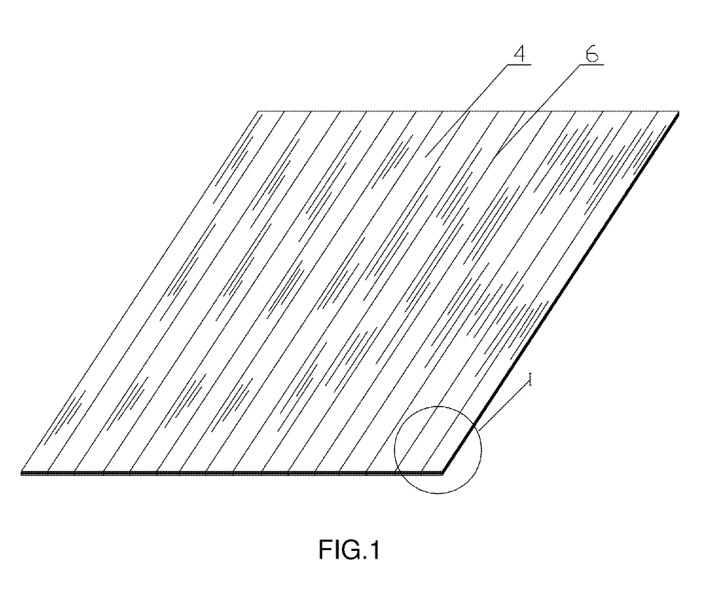

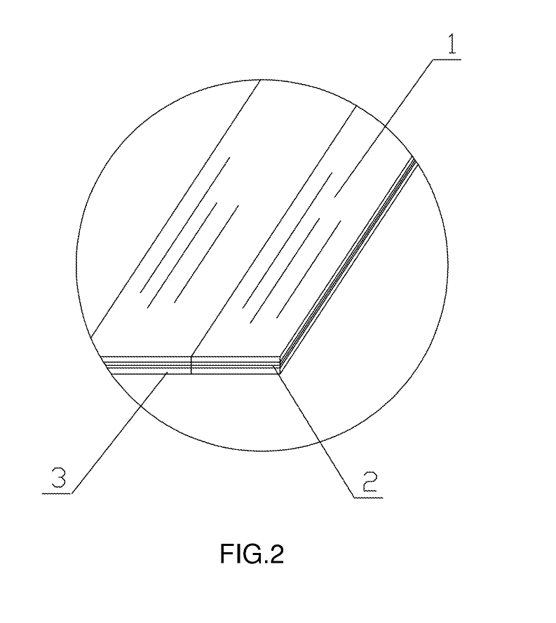

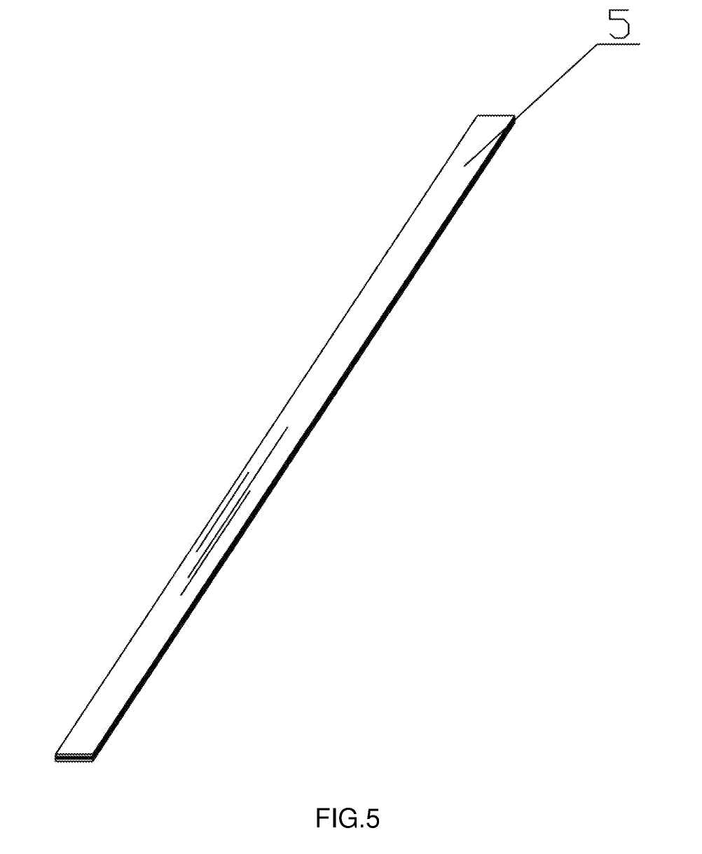

In the first embodiment, as illustrated in FIGS. 1, 2 and 5, the method of making bamboo-surfaced layered Venetian blind slats follows the steps of: (1) selecting bamboo slices 1, 3, the length of each is 3,005 mm, the width of each is 1,000 mm, the thickness of each is 0.4 mm, the longitude of the bamboo slices follows that of the bamboo fibers; (2) selecting two slices of fast growing wood slices as filling slices 2, the length and width of each are identical to those of the bamboo slices 1, 3, the thickness of each is 0.8 mm, the longitude of the filling slices follows that of their fibers; (3) selecting wood glue as adhesives and using the wood glue to adhere the bamboo slice 3, the filling slices 2, the bamboo slice 1 in turn to form a layered blind slat piece and all adjacent slices are adhered to one another along their fibers with their tight and loose surfaces arranged symmetrically; (4) placing the layered slat piece into a flat plate mold with a large surface area, using steam to control the temperature at 100° C., gluing together by means of hot compression for approximately 30 seconds, taking out and cooling under room temperature, and a flat plate with a large surface area 4 is thus obtained; (5) cutting along the cutting lines 6 of the longitude of the flat plate with a large surface area 4, and bamboo-surfaced layered Venetian blind blank slats are obtained; (6) trimming the remains of the cutting surfaces and the two end surfaces, and bamboo-surfaced layered Venetian blind slats 5 are obtained.

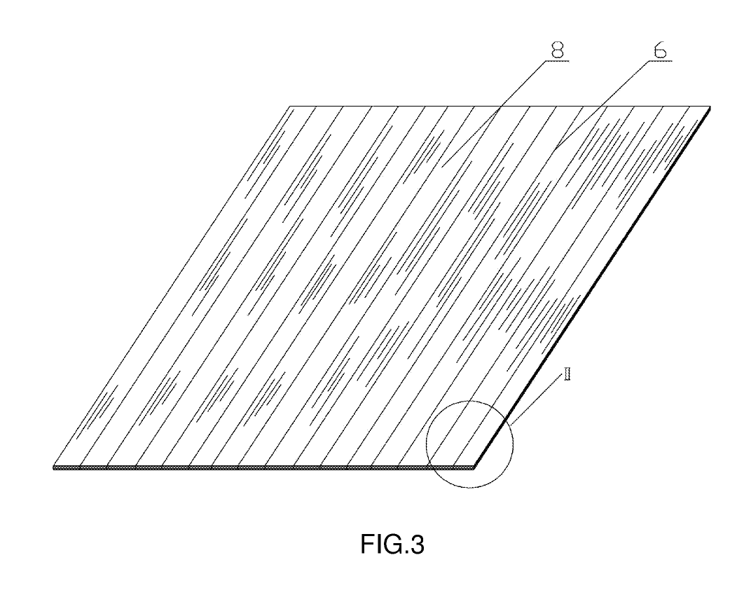

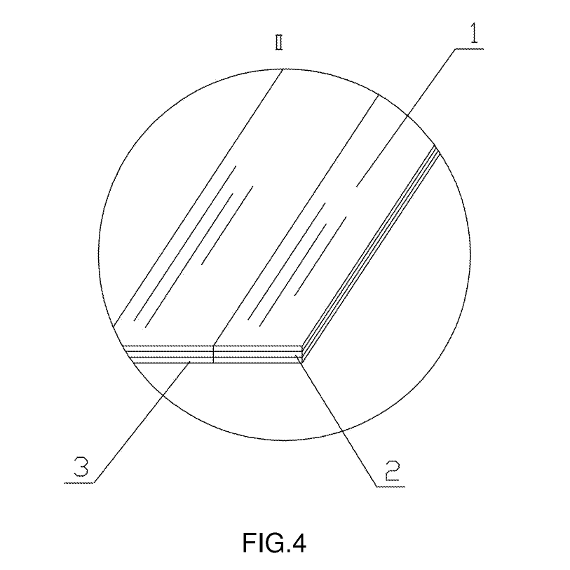

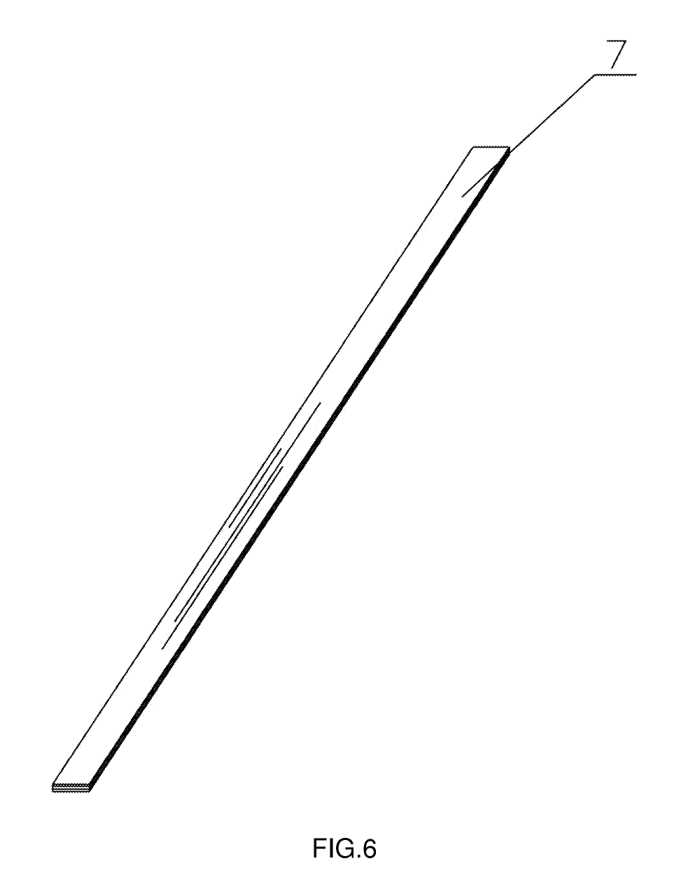

In the second embodiment, as illustrated in FIGS. 3, 4 and 6, the method of making bamboo-surfaced layered Venetian blind slats follows the steps of: (1) selecting bamboo slices 1, 3, the length of each is 3,005 mm, the width of each is 1,000 mm, the thickness of each is 0.2 mm, the longitude of the bamboo slices follows that of the bamboo fibers; (2) selecting one slice of fast growing wood slice as a filling slice 2, the length and width of the filling slice are identical to those of the bamboo slices 1, 3, the thickness of the filling slice is 1.8 mm and the longitude of the filling slice follows that of its fibers; (3) selecting wood glue as adhesives and using the wood glue to adhere the bamboo slice 3, the filling slice 2, the bamboo slice 1 in turn to form a layered blind slat piece and all adjacent slices are adhered to one another along their fibers with their tight and loose surfaces arranged symmetrically; (4) placing the layered slat piece into a flat plate mold with a large surface area, using steam to control the temperature at 100° C., gluing together by means of hot compression for approximately 30 seconds, taking out and cooling under room temperature, and a flat plate 8 with a large surface area is thus obtained; (5) cutting along the cutting lines 6 of the longitude of the flat plate with a large surface area 4, and bamboo-surfaced layered Venetian blind blank slats are obtained; (6) trimming the remains of the cutting surfaces and the two end surfaces, and bamboo-surfaced layered Venetian blind slats 7 are obtained.

The method of making bamboo-surfaced layered Venetian blind slats is also applicable in the method of making wood-surfaced layered Venetian blind slats. Any method according to which bamboo and wood slices are formed into a layered blind slat piece with all adjacent slices adhered to one another along their fibers with their tight and loose surfaces arranged symmetrically, placed in a flat plate mold to form a flat plate with a large surface area by compression, and then cut to obtain bamboo-surfaced or wood-surfaced layered Venetian blind slats, falls within the scope of protection of the present invention.

What is claimed is:

1. A method of making bamboo-surfaced layered Venetian blind slats, characterized in that, it comprises the steps of (1) selecting bamboo slices, the length of each is slightly longer than that of the slats to be made, the width of each is the total width of a plurality of the slats to be made, the longitude of the bamboo slices follows that of the bamboo fibers; (2) selecting filling slices, the length and width of each are identical to those of the bamboo slices, the longitude of the filling slices follows that of their fibers; (3) selecting adhesives and using the adhesives to adhere a bamboo slice, a filling slice, a bamboo slice in turn to form a layered slat piece and all adjacent slices are adhered to one another along their fibers with their tight and loose surfaces arranged symmetrically; (4) placing the layered blind slat piece into a flat plate mold with a large surface area, and a flat plate with a large surface area is thus formed from compression; (5) cutting along the longitude of the flat plate with a large surface area to obtain bamboo-surfaced layered Venetian blind blank slats; (6) trimming the remains of the cutting surfaces and the two end surfaces of the bamboo-surfaced layered Venetian blind blank slats, and bamboo-surfaced layered Venetian blind slats are obtained.

2. The method of making bamboo-surfaced layered Venetian blind slats as in claim 1, characterized in that, the bamboo slices in Step (1) are made by rotary slicing of raw bamboo.

3. The method of making bamboo-surfaced layered Venetian blind slats as in claim 1, characterized in that, the bamboo slices in Step (1) are made by rotary slicing of assembled laminated bamboo material.

4. The method of making bamboo-surfaced layered Venetian blind slats as in claim 1, characterized in that, the bamboo slices in Step (1) are made by plain slicing of assembled laminated bamboo material.

5. The method of making bamboo-surfaced layered Venetian blind slats as in claim 1, characterized in that, the filling slices in Step (2) are fast growing wood slices or bamboo slices.

6. The method of making bamboo-surfaced layered Venetian blind slats as in claim 1, characterized in that, the adhesives in Step (3) are wood glue.

7. The method of making bamboo-surfaced layered Venetian blind slats as in claim 1 or 5, characterized in that, there is one filling slice.

8. The method of making bamboo-surfaced layered Venetian blind slats as in claim 1 or 5, characterized in that, there are two filling slices.

9. The method of making bamboo-surfaced layered Venetian blind slats as in claim 1 or 5, characterized in that, there are multiple filling slices.
